(19) United States
(12) Patent Application Publication
(10) Pub. No.: US 2025/0319977 A1
(43) Pub. Date: Oct. 16, 2025

(54) Multi-Rotor Airspeed Calculation Method, Airspeed Envelope Protection Method, Device, and Computer-Readable Storage Medium

(71) Applicant: HANG INTELLIGENT EQUIPMENT (GUANGZHOU) CO., LTD., Guangzhou (CN)

(72) Inventors: Huazhi Hu, Guangzhou (CN); Shike Xu, Guangzhou (CN); Zhenhua Wang, Guangzhou (CN); Xianfu Wen, Guangzhou (CN)

(21) Appl. No.: 19/251,754

(22) Filed: Jun. 26, 2025

Related U.S. Application Data
(63) Continuation-in-part of application No. PCT/CN2023/139161, filed on Dec. 15, 2023.
(63) Continuation-in-part of application No. PCT/CN2023/139136, filed on Dec. 15, 2023.

(30) Foreign Application Priority Data
Dec. 28, 2022 (CN) 202211692816.6
Dec. 28, 2022 (CN) 202211727644.1

(51) Int. Cl. B64D 31/06; B64C 27/32; G08G 5/26

(52) U.S. Cl. CPC B64D 31/06; B64C 27/32; G08G 5/26

(57) ABSTRACT

A method, device, and computer-readable storage medium for multi-rotor airspeed calculation and airspeed envelope protection is disclosed. The airspeed calculation method includes: establishing an airspeed calculation mathematical model; defining a function ƒ(V) based on the airspeed calculation mathematical model for each calculation cycle, and combining real-time measurements of tilt angle θ and acceleration aₓ, using the Newton iteration algorithm to solve the root of the equation ƒ(V)=0 in real time as the real-time airspeed V to control flight of the multi-rotor. An airspeed calculation scheme is implemented based on dynamics principles, fully utilizing dynamics principles and combining the unique control methods of multi-rotors. Without adding hardware sensors, it uses known attitude measurements and acceleration measurements as algorithm inputs, and calculates airspeed data with sufficient accuracy through software algorithms, simplifying the hardware structure, reducing the risk of electrical failure, and saving manufacturing, debugging, and maintenance costs.

### CROSS REFERENCE TO RELATED APPLICATIONS

The present application is a Continuation-In-Part application of PCT Application No. PCT/CN2023/139136 filed on Dec. 15, 2023, which claims the benefit of Chinese Patent Application No. 202211727644.1 filed on Dec. 28, 2022. The present application is also a Continuation-In-Part application of PCT Application No. PCT/CN2023/139161 filed on Dec. 15, 2023, which claims the benefit of Chinese Patent Application No. 202211692816.6 filed on Dec. 28, 2022. All the above are hereby incorporated by reference in their entirety.

### TECHNICAL FIELD

The present disclosure relates to the technical field of unmanned aerial vehicles, and in particular, to a multi-rotor airspeed calculation method, an airspeed envelope protection method, a device, and a computer-readable storage medium.

### BACKGROUND ART

Currently, unlike traditional aerial vehicles, the speed control of multi-rotor aerial vehicles (abbreviated as “multi-rotor” hereinafter) typically relies on ground speed control rather than airspeed control. As a result, multi-rotor aerial vehicles generally do not incorporate airspeed sensors. However, for large multi-rotor aerial vehicles, airworthiness safety requirements and considerations for structural load strength often necessitate airspeed measurement and airspeed envelope protection.

In existing solutions, traditional airspeed measurement devices based on dynamic/static pressure principles can be installed on large multi-rotor aerial vehicles to meet these requirements. However, such traditional airspeed sensors face significant limitations when applied to large multi-rotor aerial vehicles: first, they are susceptible to interference from turbulent airflow caused by multiple propellers, or avoiding such interference requires significant structural installation costs; second, for multi-rotor aerial vehicles, airspeed measurements are not directly integrated into control laws, and the addition of airspeed meters increases manufacturing, debugging, and maintenance costs.

Airspeed envelope protection is critical for the safety of aerial vehicles structural loads. For traditional aerial vehicles, airspeed envelope protection measures typically rely on airspeed indications from dynamic/static pressure-based airspeed meters, with pilots or flight control systems actively ensuring that the airspeed does not exceed the envelope. For general multi-rotor aerial vehicles, due to differences in control methods or environmental interference from installation conditions, dynamic/static pressure-based airspeed meters may not be available. This poses challenges to achieving airspeed envelope protection for multi-rotor aerial vehicles.

Therefore, developing an airspeed calculation algorithm based on dynamics principles without adding hardware sensors, and implementing airspeed envelope protection, has become an urgent technical problem to be addressed.

### SUMMARY OF THE INVENTION

### Technical Problem

In view of this, the present disclosure proposes a multi-rotor airspeed calculation method, an airspeed envelope protection method, a device, and a computer-readable storage medium to address the issue of calculating airspeed with sufficient accuracy based on known attitude measurements and acceleration measurements without adding hardware sensors, thereby reducing the risk of electrical failure and manufacturing costs.

### Technical Solution

The present disclosure proposes a multi-rotor airspeed calculation method, including: establishing an airspeed calculation mathematical model k₁(θ)·V+k₂(θ)·V²+k₃(θ)·V³=mg tan θ−maₓ, where m is the mass, g is the gravitational acceleration, θ is the tilt angle, aₓ is the acceleration, V is the airspeed, and k₁(θ), k₂(θ), k₃(θ) are preset first-order, second-order, and third-order drag coefficient functions, respectively; and defining a function ƒ(V) based on the airspeed calculation mathematical model for each calculation cycle, where ƒ(V)=k₃(θ)·V³+k₂(θ)·V²+k₁(θ)·V−mg tan θ+maₓ, with the tilt angle θ and the acceleration aₓ being real-time measured values of flight of a multi-rotor vehicle, and using a Newton iteration algorithm to solve a root of an equation ƒ(V)=0 in real time as the real-time airspeed V.

Optionally, before establishing the airspeed calculation mathematical model, the method includes:
establishing a 6-degree-of-freedom (6DOF) dynamics constraint equation in a body horizontal coordinate system O−XYZ:

$$\{ \begin{matrix}\sum {F}_{Px} + \sum {F}_{Lx} + \sum {F}_{Dx} = {ma}_{x} + {mv}_{x} {w}_{z} \\ \sum {F}_{Py} + \sum {F}_{Ly} + \sum {F}_{Dy} = {ma}_{y} + {mv}_{y} {w}_{z} \\ \sum {F}_{Pz} + \sum {F}_{Lz} + \sum {F}_{Dz} - mg = {ma}_{z} \\ \sum {M}_{x} = {J}_{x} {α}_{x} + {\dot{J}}_{x} {w}_{x} + {J}_{x} {w}_{x} {w}_{z} \\ \sum {M}_{y} = {J}_{y} {α}_{y} + {\dot{J}}_{y} {w}_{y} + {J}_{y} {w}_{y} {w}_{z} \\ \sum {M}_{z} = {J}_{z} {α}_{z} + {\dot{J}}_{z} {w}_{z}\end{matrix} ;$$

where ΣF_{P} is the total thrust generated by propeller rotation, ΣF_{L} is the lift generated by movement of a fuselage of the multi-rotor vehicle in an airflow field, ΣF_{D} is the total aerodynamic drag of the multi-rotor vehicle, ΣM is the total torque of the multi-rotor vehicle, J is the moment of inertia of the multi-rotor vehicle, a is the linear acceleration of the center of mass, w is the angular velocity of a rigid body motion of the multi-rotor vehicle, and α is the angular acceleration of the rigid body motion of the multi-rotor vehicle.

The present disclosure also proposes a multi-rotor airspeed envelope protection method, including:
establishing an airspeed mathematical model: m\dot{V}=−(k₁(θ)·V+k₂(θ)·V²+k₃(θ)·V³)+mg tan θ, where m is the mass, g is the gravitational acceleration, θ is the tilt angle, V is the airspeed, and k₁(θ), k₂(θ), k₃(θ) are first-order, second-order, and third-order drag coefficient functions, respectively;
determining a correspondence between the maximum tilt angle and the maximum steady-state airspeed based on the airspeed mathematical model, and obtaining a tilt angle restriction parameter introduced into attitude control based on the correspondence; and calculating a transient airspeed based on the airspeed mathematical model, attitude measurement, and acceleration measurement, and executing a corresponding airspeed protection procedure based on a detection result of the transient airspeed.

Optionally, establishing the airspeed mathematical model includes:
establishing an airspeed calculation mathematical model: maₓ=−(k₁(θ)·V+k₂(θ)·V²+k₃(θ)·V³)+mg tan θ, where aₓ is an acceleration;
determining kinematic constraint satisfied by longitudinal motion:

$$\{ \begin{matrix}V = {V}_{wind} + {V}_{gnd} \\ {a}_{x} = {\dot{V}}_{gnd} = \dot{V} - {\dot{V}}_{wind}\end{matrix} ;$$

where V_{wind} is an incoming wind speed, and V_{gnd} is a ground speed.

Optionally, establishing the airspeed mathematical model further includes:
for a steady flow field with no wind, constant, or slowly varying gusts, setting \dot{V}_{wind}≈0;
for an unsteady flow field with gusts, setting \dot{V}_{wind}≈0 in a steady state;
combining the airspeed calculation mathematical model and the kinematic constraint satisfied by the longitudinal motion to establish the airspeed mathematical model.

The present disclosure also proposes a multi-rotor airspeed calculation device, including a memory, a processor, and a computer program stored in the memory and executable on the processor. The computer program, when executed by the processor, implements the steps of any of the multi-rotor airspeed calculation methods and/or multi-rotor airspeed envelope protection methods described above.

The present disclosure further proposes a computer-readable storage medium having a multi-rotor airspeed calculation program stored thereon. The multi-rotor airspeed calculation program, when executed by a processor, implements the steps of any of the multi-rotor airspeed calculation methods and/or multi-rotor airspeed envelope protection methods described above.

### Beneficial Effects

Implementing the multi-rotor airspeed calculation method, device, and computer-readable storage medium of the present disclosure involves establishing an airspeed calculation mathematical model k₁(θ)·V+k₂(θ)·V²+k₃(θ)·V³=mg tan θ−maₓ, where m is the mass, g is the gravitational acceleration, θ is the tilt angle, aₓ is the acceleration, V is the airspeed, and k₁(θ), k₂(θ), k₃(θ) are preset first-order, second-order, and third-order drag coefficient functions, respectively; and defining a function ƒ(V) based on the airspeed calculation mathematical model for each calculation cycle, where ƒ(V)=k₃(θ)·V³+k₂(θ)·V²+k₁(θ)·V−mg tan θ+maₓ, with the tilt angle θ and the acceleration aₓ being real-time measured values of flight of a multi-rotor vehicle, and using a Newton iteration algorithm to solve a root of an equation ƒ(V)=0 in real time as the real-time airspeed V to control the flight of the multi-rotor vehicle. This achieves an airspeed calculation scheme based on dynamics principles, fully utilizing dynamics principles and combining the unique control methods of multi-rotors. Without adding hardware sensors, it uses known attitude measurements and acceleration measurements as algorithm inputs, and calculates airspeed data with sufficient accuracy through software algorithms, simplifying the hardware structure, reducing the risk of electrical failure, and saving manufacturing, debugging, and maintenance costs.

Implementing the multi-rotor airspeed envelope protection method, device, and computer-readable storage medium of the present disclosure involves establishing an airspeed mathematical model; determining the correspondence between the maximum tilt angle and the maximum steady-state airspeed based on the airspeed mathematical model, and obtaining the tilt angle restriction parameter introduced into attitude control based on the correspondence; and calculating the transient airspeed based on the airspeed mathematical model, attitude measurements, and acceleration measurements, and executing the corresponding airspeed protection procedure based on the detection results of the transient airspeed. This achieves an airspeed envelope protection scheme that utilizes dynamics principles and does not rely on traditional airspeed sensor observations, effectively saving hardware and maintenance costs while ensuring flight safety.

### DESCRIPTION OF THE DRAWINGS

The present disclosure will be further described below with reference to the drawings and embodiments, in which:

FIG. 1 is the first flowchart of the multi-rotor airspeed calculation method of the present disclosure;

FIG. 2 is a schematic diagram of the coordinate system for the multi-rotor airspeed calculation method of the present disclosure;

FIG. 3 is a schematic diagram of the longitudinal motion force analysis under reference motion for the multi-rotor airspeed calculation method of the present disclosure;

FIG. 4 is the first flowchart of the multi-rotor airspeed envelope protection method of the present disclosure;

FIG. 5 is the second flowchart of the multi-rotor airspeed envelope protection method of the present disclosure;

FIG. 6 is the third flowchart of the multi-rotor airspeed envelope protection method of the present disclosure;

FIG. 7 is the fourth flowchart of the multi-rotor airspeed envelope protection method of the present disclosure;

FIG. 8 is the fifth flowchart of the multi-rotor airspeed envelope protection method of the present disclosure;

FIG. 9 is the sixth flowchart of the multi-rotor airspeed envelope protection method of the present disclosure; and

FIG. 10 is the seventh flowchart of the multi-rotor airspeed envelope protection method of the present disclosure.

### DETAILED DESCRIPTION

It should be understood that the specific embodiments described herein are only used to explain the present disclosure and are not intended to limit the present disclosure.

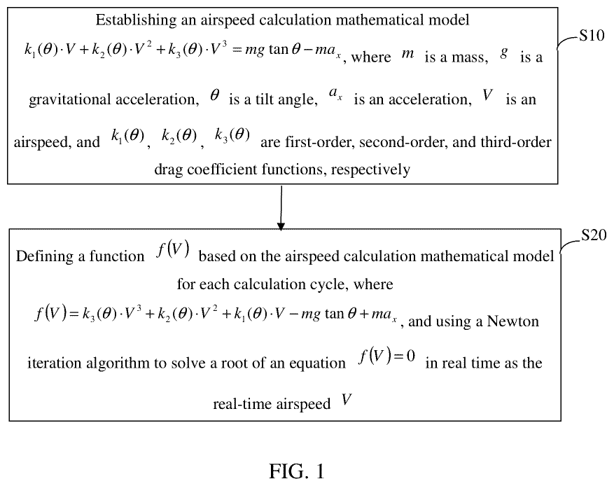

FIG. 1 is a first flowchart of the multi-rotor airspeed calculation method of the present disclosure. This embodiment proposes a multi-rotor airspeed calculation method, which includes:
S10. establishing an airspeed calculation mathematical model k₁(θ)·V+k₂(θ)·V²+k₃(θ)·V³=mg tan θ−maₓ, where m is the mass, g is the gravitational acceleration, θ is the tilt angle, aₓ is the acceleration, V is the airspeed, and k₁(θ), k₂(θ), k₃(θ) are preset first-order, second-order, and third-order drag coefficient functions, respectively;
S20. defining a function ƒ(V) based on the airspeed calculation mathematical model for each calculation cycle, where ƒ(V)=k₃(θ)·V³+k₂(θ)·V²+k₁(θ)·V−mg tan θ+maₓ, with the tilt angle θ and the acceleration aₓ being real-time measured values of flight of a multi-rotor vehicle, and using a Newton iteration algorithm to solve a root of an equation ƒ(V)=0 in real time as the real-time airspeed V.

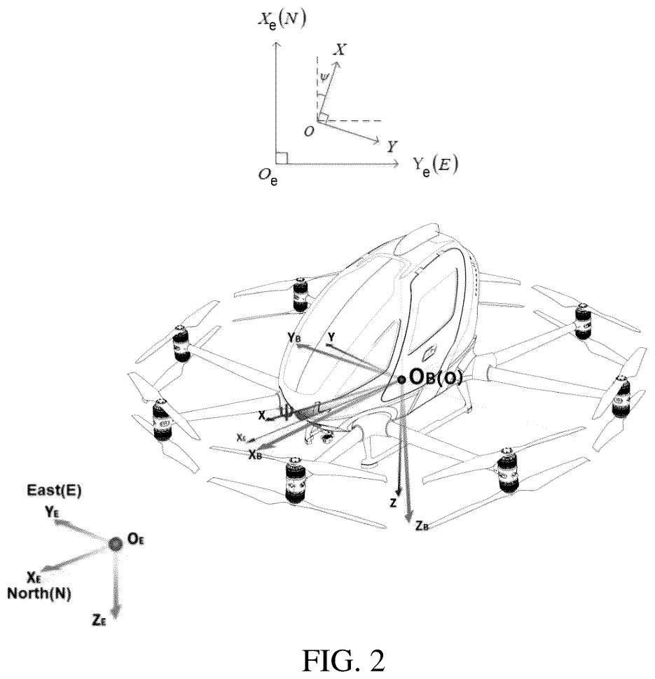

Please refer to FIG. 2, which illustrates a diagram defining the coordinate system. In this embodiment, first, the following coordinate systems are defined: the ground coordinate system O_{E}−X_{E}Y_{E}Z_{E}; the body coordinate system O_{B}−X_{B}Y_{B}Z_{B}; and the body horizontal coordinate system (i.e., a custom coordinate system) O−XYZ. The origin O is set at the center of mass of the aerial vehicle, OX is set in the plane of symmetry of the fuselage, pointing horizontally forward, OZ points vertically downward, and OY follows the right-hand rule, pointing horizontally to the right side of the fuselage.

In this embodiment, the following symbol conventions are then established: ΣF_{P} and Fₚᵣₒₚ are the total thrust generated by propeller rotation, ΣF_{L} is the lift generated by movement of a fuselage of the multi-rotor vehicle in an airflow field, ΣF_{D} and F_{drag} are the total aerodynamic drag of the multi-rotor vehicle, ΣM is the total torque of the multi-rotor vehicle, which includes the active moment generated by the propeller rotation and additional moments from other aerodynamic forces, m is the mass of the multi-rotor vehicle, J is the moment of inertia of the multi-rotor vehicle, v is the linear velocity of the center of mass, a is the linear acceleration of the center of mass, w is the angular velocity of a rigid body motion of the multi-rotor vehicle, α is the angular acceleration of the rigid body motion of the multi-rotor vehicle, g is the gravitational acceleration, V is the airspeed, V_{wind} is the incoming wind speed, V_{gnd} is the ground speed, V_{des} is the target ground speed, θ is the fuselage horizontal tilt angle (i.e., the roll or pitch angle of the fuselage). Optionally, for longitudinal motion, θ is the pitch angle. k₁(θ), k₂(θ), k₃(θ) are the first-order, second-order, and third-order drag coefficient functions, respectively, related to the dynamic behavior of the tilt angle. Optionally, the tilt angle θ and the acceleration aₓ are real-time measured values. Furthermore, in this embodiment, it is stipulated that the subscript x, y, z indicates the projection or component along the three axes of the body horizontal coordinate system, and the subscript x_{b}, y_{b}, z_{b}(xₑ, yₑ, zₑ) indicates the projection or component along the three axes of the body coordinate system (i.e., ground coordinate system).

In this embodiment, the airspeed calculation mathematical model is analyzed as follows: the mass m and gravitational acceleration g are known quantities. Based on aerodynamic knowledge, the drag coefficients k₁(θ), k₂(θ), k₃(θ) have a definite functional relationship with the tilt angle θ. This functional relationship can be obtained offline through aerodynamic simulation or experimental calibration. Historically, aerial vehicles design has relied on aerodynamic simulation tests to determine the functional relationship between the drag coefficients k₁(θ), k₂(θ), k₃(θ) and the tilt angle θ, meaning this relationship can be considered a known function. The tilt angle θ can be measured in real time by the attitude estimation system of the flight control system, and the acceleration aₓ can be measured in real time by the accelerometer of the flight control system or derived through attitude transformation of the accelerometer's measurements. Thus, θ and aₓ are measurable known quantities. Furthermore, in this embodiment, considering that the airspeed calculation model in each calculation cycle is a cubic equation with respect to the airspeed V, this embodiment defines the function:

$$f ( V ) = {k}_{3} ( θ ) \cdot {V}^{3} + {k}_{2} ( θ ) \cdot {V}^{2} + {k}_{1} ( θ ) \cdot V - mg tan θ + {ma}_{x}$$

Furthermore, in this embodiment, the Newton iteration algorithm is employed to solve the root of the equation ƒ(V)=0 in real time, which serves as the current real-time airspeed V of the multi-rotor aerial vehicles.

Optionally, in this embodiment, before establishing the airspeed calculation mathematical model, the method includes:
establishing a 6-degree-of-freedom (6DOF) dynamics constraint equation in a body horizontal coordinate system O−XYZ:

$$\{ \begin{matrix}\sum {F}_{Px} + \sum {F}_{Lx} + \sum {F}_{Dx} = {ma}_{x} + {mv}_{x} {w}_{z} \\ \sum {F}_{Py} + \sum {F}_{Ly} + \sum {F}_{Dy} = {ma}_{y} + {mv}_{y} {w}_{z} \\ \sum {F}_{Pz} + \sum {F}_{Lz} + \sum {F}_{Dz} - mg = {ma}_{z} \\ \sum {M}_{x} = {J}_{x} {α}_{x} + {\dot{J}}_{x} {w}_{x} + {J}_{x} {w}_{x} {w}_{z} \\ \sum {M}_{y} = {J}_{y} {α}_{y} + {\dot{J}}_{y} {w}_{y} + {J}_{y} {w}_{y} {w}_{z} \\ \sum {M}_{z} = {J}_{z} {α}_{z} + {\dot{J}}_{z} {w}_{z}\end{matrix} ;$$

where ΣF_{P} is the total thrust generated by propeller rotation, F_{L} is the lift generated by movement of a fuselage of the multi-rotor vehicle in an airflow field, ΣF_{D} is the total aerodynamic drag of the multi-rotor vehicle, ΣM is the total torque of the multi-rotor vehicle, j is the moment of inertia of the multi-rotor vehicle, a is the linear acceleration of the center of mass, w is the angular velocity of a rigid body motion of the multi-rotor vehicle, and α is the angular acceleration of the rigid body motion of the multi-rotor vehicle.

Optionally, in this embodiment, before establishing the airspeed calculation mathematical model, the following step is also included:
based on the general flight mode of the multi-rotor aerial vehicles, i.e., the steady-state linear level flight mode, and under control law constraints of attitude stabilization, altitude hold, and position tracking, determining following assumptions:
a three-axis attitude changes slowly, with a three-axis angular velocity ωₓ≈ω_{y}≈ω_{z}≈0, a three-axis acceleration αₓ≈α_{y}≈α_{z}≈0;
vertical motion changes slowly, with a vertical acceleration a_{z}≈0;
a three-axis moment of inertia changes slowly, \dot{J}ₓ≈\dot{J}_{y}≈\dot{J}_{z}≈0;
a propeller lift is significantly greater than a fuselage lift, i.e., ΣF_{Lx}≈0, ΣF_{Ly}≈0, ΣF_{Lz}≈0.

Optionally, in this embodiment, before establishing the airspeed calculation mathematical model, the following step is also included:
simplifying the 6DOF dynamics constraint equation based on the assumptions to obtain a 3-degree-of-freedom dynamics equation for longitudinal and lateral linear motions:

$$\{ \begin{matrix}\sum {F}_{Px} + \sum {F}_{Dx} = {ma}_{x} \\ \sum {F}_{Py} + \sum {F}_{Dy} = {ma}_{y} \\ \sum {F}_{Pz} - mg = 0\end{matrix} .$$

In the aforementioned 3DOF dynamics equations for longitudinal and lateral linear motion in this embodiment, the lateral and longitudinal dynamics models are decoupled. Only the modeling process of the longitudinal (i.e., XOZ-plane) dynamics model is described, and its conclusions also apply to lateral motion. It should be noted that, in this embodiment, for longitudinal dynamics modeling, the subscript x, y, z is omitted from symbols unless it causes ambiguity.

Optionally, in this embodiment, before establishing the airspeed calculation mathematical model, the following step is included:
establishing a longitudinal motion dynamics constraint equation:

$$\{ \begin{matrix}{F}_{prop} sin θ - {F}_{drag} = {ma}_{x} \\ {F}_{prop} cos θ - mg = 0\end{matrix} .$$

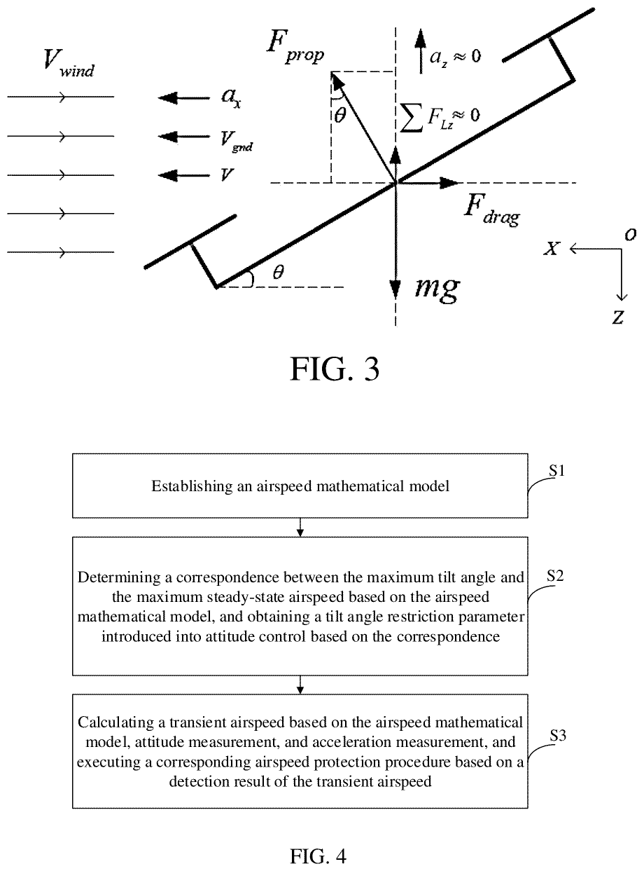

Please refer to the force analysis schematic for longitudinal motion under the reference motion shown in FIG. 3, where Fₚᵣₒₚ is the total thrust generated by the propeller rotation, and F_{drag} is the total aerodynamic drag of the aerial vehicles.

Optionally, in this embodiment, before establishing the airspeed calculation mathematical model, the following step is also included:
establishing a longitudinal motion aerodynamic drag constraint equation:

$${F}_{drag} = {k}_{1} ( θ ) \cdot V + {k}_{2} ( θ ) \cdot {V}^{2} + {k}_{3} ( θ ) \cdot {V}^{3} .$$

Optionally, in this embodiment, establishing the airspeed calculation mathematical model includes:
establishing the airspeed calculation mathematical model based on the longitudinal motion dynamics constraint equation and the longitudinal motion aerodynamic drag constraint equation:

$${k}_{1} ( θ ) \cdot V + {k}_{2} ( θ ) \cdot {V}^{2} + {k}_{3} ( θ ) \cdot {V}^{3} = mg tan θ - {ma}_{x} .$$

Optionally, in this embodiment, the method further includes:
performing airspeed calculation based on the airspeed calculation mathematical model under conditions of no wind at ground level, steady flow field, or turbulent gusts.

In this embodiment, considering that the modeling and solving process of the airspeed calculation model does not impose requirements on the external airflow state, the airspeed calculation algorithm proposed in this embodiment is applicable to no-wind ground conditions, steady flow field conditions, and turbulent gust conditions.

The beneficial effects of this embodiment lie in: through establishing an airspeed calculation mathematical model k₁(θ)·V+k₂(θ)·V²+k₃(θ)·V³=mg tan θ−maₓ, where m is the mass, g is the gravitational acceleration, θ is the tilt angle, aₓ is the acceleration, V is the airspeed, and k₁(θ), k₂(θ), k₃(θ) are preset first-order, second-order, and third-order drag coefficient functions, respectively; defining a function ƒ(V) based on the airspeed calculation mathematical model for each calculation cycle, where ƒ(V)=k₃(θ)·V³+k₂(θ)·V²+k₁(θ)·V−mg tan θ+maₓ, with the tilt angle θ and the acceleration aₓ being real-time measured values of flight of a multi-rotor vehicle, and using a Newton iteration algorithm to solve a root of an equation ƒ(V)=0 in real time as the real-time airspeed V, an airspeed calculation scheme is implemented based on dynamics principles, fully utilizing dynamics principles and combining the unique control methods of multi-rotors. Without adding hardware sensors, it uses known attitude measurements and acceleration measurements as algorithm inputs, and calculates airspeed data with sufficient accuracy through software algorithms, simplifying the hardware structure, reducing the risk of electrical failure, and saving manufacturing, debugging, and maintenance costs.

Based on the above embodiment, the present disclosure further proposes a multi-rotor airspeed calculation device, which includes a memory, a processor, and a computer program stored in the memory and executable on the processor. When the computer program is executed by the processor, it implements the steps of the multi-rotor airspeed calculation method as described in any of the above.

It should be noted that the device embodiment and the method embodiment belong to the same concept, and the specific implementation process is detailed in the method embodiment. The technical features in the method embodiment are correspondingly applicable in the device embodiment, and thus are not repeated here.

Based on the above embodiment, the present disclosure further proposes a computer-readable storage medium, on which a multi-rotor airspeed calculation program is stored. When the multi-rotor airspeed calculation program is executed by a processor, it implements the steps of the multi-rotor airspeed calculation method as described in any of the above.

It should be noted that the medium embodiment and the method embodiment belong to the same concept, and the specific implementation process is detailed in the method embodiment.

The technical features in the method embodiment are correspondingly applicable in the medium embodiment, and thus are not repeated here.

FIG. 4 is a flowchart of the multi-rotor airspeed envelope protection method of the present disclosure. This embodiment proposes a multi-rotor airspeed envelope protection method, which includes:
S1. establishing an airspeed mathematical model: m\dot{V}=−(k₁(θ)·V+k₂(θ)·V²+k₃(θ)·V³)+mg tan θ, where m is the mass, g is the gravitational acceleration, θ is the tilt angle, V is the airspeed, and k₁(θ), k₂(θ), k₃(θ) are first-order, second-order, and third-order drag coefficient functions, respectively;
S2. determining a correspondence between the maximum tilt angle and the maximum steady-state airspeed based on the airspeed mathematical model, and obtaining a tilt angle restriction parameter introduced into attitude control based on the correspondence;
S3. calculating a transient airspeed based on the airspeed mathematical model, attitude measurement, and acceleration measurement, and executing a corresponding airspeed protection procedure based on a detection result of the transient airspeed.

In this embodiment, first, the following coordinate systems are defined: the ground coordinate system O_{E}−X_{E}Y_{E}Z_{E}; the body coordinate system O_{B}−X_{B}Y_{B}Z_{B}; and the body horizontal coordinate system (i.e., a custom coordinate system) O−XYZ. The origin O is set at the center of mass of the aerial vehicle, OX is set in the plane of symmetry of the fuselage, pointing horizontally forward, OZ points vertically downward, and OY follows the right-hand rule, pointing horizontally to the right side of the fuselage.

In this embodiment, second, the symbol conventions are established as follows: a is the linear acceleration of the center of mass, g is the gravitational acceleration, V is the airspeed, V_{wind} is the incoming wind speed, V_{gnd} is the ground speed, θ is the fuselage horizontal tilt angle, and optionally, for longitudinal motion, θ represents the pitch angle. k₁(θ), k₂(θ), k₃(θ) are first-order, second-order, and third-order drag coefficient functions, respectively, related to the dynamic behavior of the tilt angle.

In this embodiment, it is stipulated that the subscript x, y, z indicates the projection or component along the three axes of the body horizontal coordinate system, and the subscript x_{b}, y_{b}, z_{b} (xₑ, yₑ, zₑ) indicates the projection or component along the three axes of the body coordinate system (i.e., ground coordinate system).

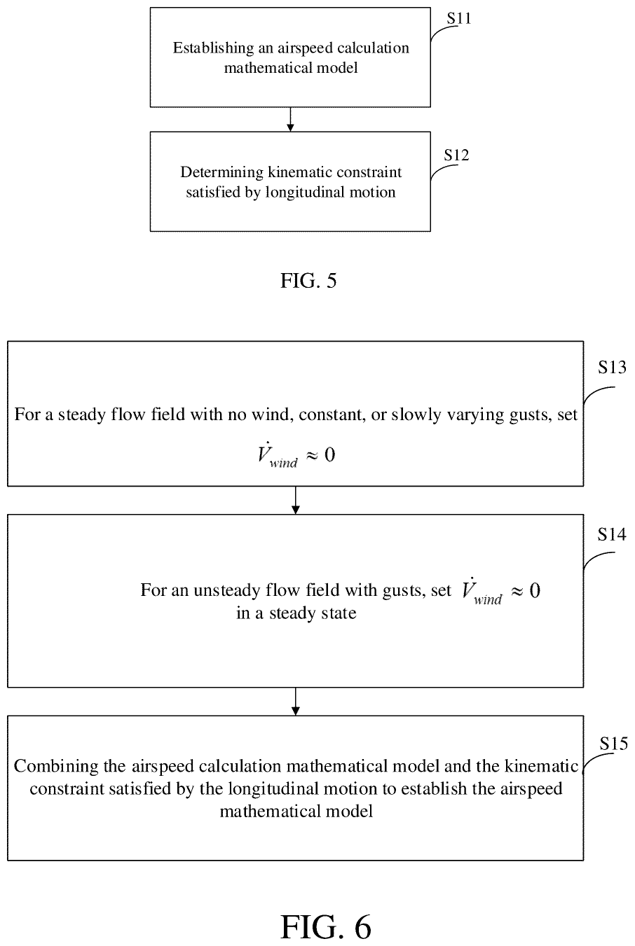

Optionally, please refer to FIG. 5, establishing the airspeed mathematical model includes:
S11. establishing an airspeed calculation mathematical model: maₓ=−(k₁(θ)·V+k₂(θ)·V²+k₃(θ)·V³)+mg tan θ, where aₓ is the acceleration;
S12. determining kinematic constraint satisfied by longitudinal motion:

$$\{ \begin{matrix}V = {V}_{wind} + {V}_{gnd} \\ {a}_{x} = {\dot{V}}_{gnd} = \dot{V} - {\dot{V}}_{wind}\end{matrix} ;$$

where V_{wind} is the incoming wind speed, and V_{gnd} is the ground speed.

Optionally, please refer to FIG. 6, establishing the airspeed mathematical model further includes:
S13. for a steady flow field with no wind, constant, or slowly varying gusts, set \dot{V}_{wind}≈0;
S14. for an unsteady flow fields such as gusts, due to energy attenuation, the wind speed at the end of the gust can be considered to have a decay characteristic, i.e. \dot{V}_{wind}≤0; therefore, its steady state is taken as \dot{V}_{wind}≈0;
S15. combining the airspeed calculation mathematical model and the kinematic constraint satisfied by the longitudinal motion to establish the airspeed mathematical model.

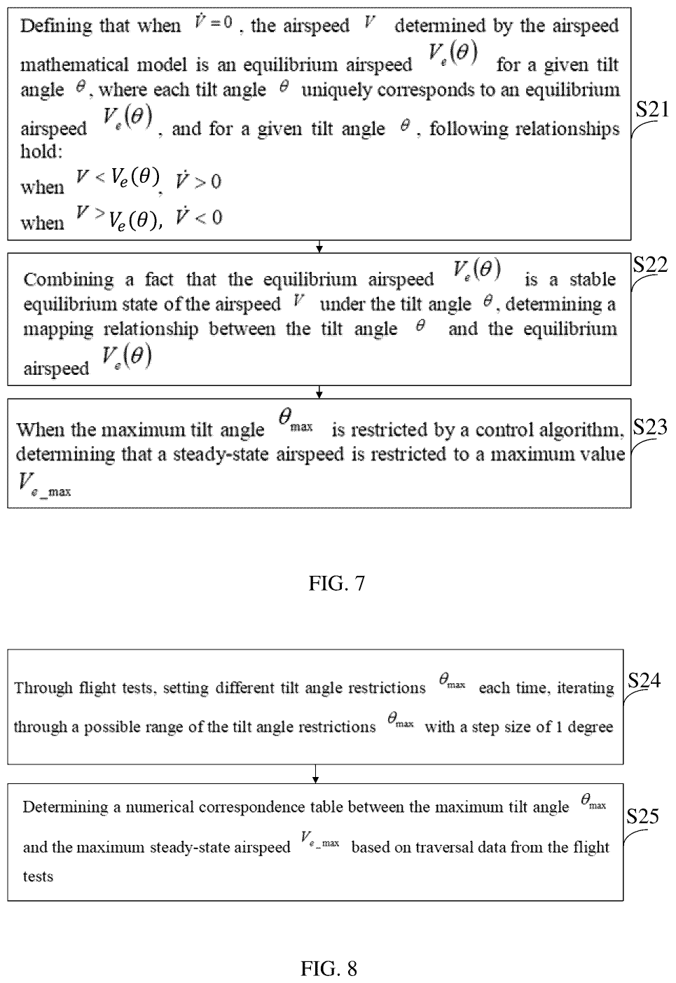

Optionally, please refer to FIG. 7, determining the correspondence between the maximum tilt angle and the maximum steady-state airspeed based on the airspeed mathematical model, and obtaining the tilt angle restriction parameter introduced into the attitude control based on the correspondence, includes:
S21. defining that when \dot{V}=0, the airspeed V determined by the airspeed mathematical model is an equilibrium airspeed Vₑ(θ) for a given tilt angle θ, where each tilt angle θ uniquely corresponds to an equilibrium airspeed Vₑ(θ), and for a given tilt angle θ, following relationships hold:
when V<Vₑ(θ), \dot{V}>0;
when V>Vₑ(θ), \dot{V}<0;
S22. combining a fact that the equilibrium airspeed Vₑ(θ) is a stable equilibrium state of the airspeed V under the tilt angle θ, there exists a one-to-one a mapping relationship between the tilt angle θ and the equilibrium airspeed Vₑ(θ), i.e., the larger the tilt angle θ, the larger the equilibrium airspeed;
S23. based on this mapping relationship, when the maximum tilt angle θₘₐₓ is restricted by a control algorithm, determining that a steady-state airspeed is restricted to a maximum value V_{e_max}.

Thus, this embodiment can determine the mapping relationship between the tilt angle θ and the equilibrium airspeed Vₑ(θ).

Optionally, in this embodiment, for gust disturbances, the transient airspeed V may briefly exceed the steady-state airspeed Vₑ(θ). However, as time progresses and gust energy attenuates, the steady-state airspeed will still recover to Vₑ(θ). Therefore, this embodiment treats the effect of gusts on airspeed as a transient disturbance, with the steady state still satisfying the dynamics model shown in the airspeed mathematical model above.

Optionally, please refer to FIG. 8, determining the correspondence between the maximum tilt angle and the maximum steady-state airspeed based on the airspeed mathematical model, and obtaining the tilt angle restriction parameter introduced into the attitude control based on the correspondence, further includes:
S24. conducting flight tests, setting different tilt angle restrictions θₘₐₓ each time, and iterating through a possible range of the tilt angle restrictions θₘₐₓ with a step size of 1 degree;
S25. determining a numerical correspondence table between the maximum tilt angle θₘₐₓ and the maximum steady-state airspeed V_{e_max} based on traversal data from the flight tests.

In this embodiment, for tilt angle constraint protection, analysis of the airspeed mathematical model indicates a one-to-one mapping relationship between the tilt angle θ and the equilibrium airspeed Vₑ(θ). By limiting the maximum tilt angle θₘₐₓ, the maximum steady-state airspeed of the multi-rotor is also constrained to V_{e_max}. Therefore, this embodiment introduces a tilt angle constraint in the attitude control, limiting the tilt angle through the algorithm to achieve the purpose of restricting the steady-state airspeed.

Optionally, in this embodiment, a tilt angle constraint is incorporated into the attitude control, with the constraint value configurable through parameter settings.

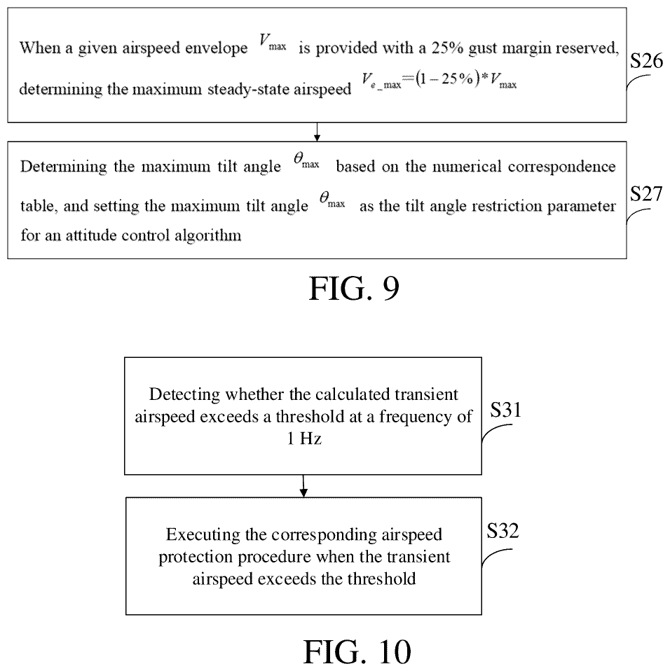

Optionally, please refer to FIG. 9, determining the correspondence between the maximum tilt angle and the maximum steady-state airspeed based on the airspeed mathematical model, and obtaining the tilt angle restriction parameter introduced into the attitude control based on the correspondence, further includes:
S26. when a given airspeed envelope Vₘₐₓ is provided with a 25% gust margin reserved, determining the maximum steady-state airspeed V_{e_max}=(1-25%)*Vₘₐₓ;
S27. determining the maximum tilt angle θₘₐₓ based on the numerical correspondence table, and setting the maximum tilt angle θₘₐₓ as the tilt angle restriction parameter for an attitude control algorithm.

Optionally, please refer to FIG. 10, calculating the transient airspeed based on the airspeed mathematical model, the attitude measurements, and the acceleration measurements, and executing the corresponding airspeed protection procedure based on the detection result of the transient airspeed, includes:
S31. detecting whether the calculated transient airspeed exceeds a threshold at a frequency of 1 Hz;
S32. executing the corresponding airspeed protection procedure when the transient airspeed exceeds the threshold.

Optionally, calculating the transient airspeed based on the airspeed mathematical model, the attitude measurements, and the acceleration measurements, and executing the corresponding airspeed protection procedure based on the detection result of the transient airspeed, further includes:
when k1*Vₘₐₓ≤V<k2*Vₘₐₓ, sending a warning message to a ground station and requiring a remote crew to continuously monitor an airspeed status;
when k2*Vₘₐₓ≤V<Vₘₐₓ, actively reducing a target speed through a flight controller and decreasing the tilt angle until the airspeed is below k1*Vₘₐₓ;
when V≥Vₘₐₓ, controlling the multi-rotor vehicle through the flight controller to decelerate to a hover state and initiating a return or landing;
where k1<k2.

Optionally, in this embodiment, the value range of k1 is 0.5 to 0.8, and the value range of k2 is 0.7 to 0.9.

The beneficial effect of this embodiment lies in: establishing an airspeed mathematical model; determining the correspondence between the maximum tilt angle and the maximum steady-state airspeed based on the airspeed mathematical model, and obtaining the tilt angle constraint parameter introduced into the attitude control based on the correspondence; calculating the transient airspeed based on the airspeed mathematical model, attitude measurements, and acceleration measurements, and executing the corresponding airspeed protection procedure based on the detection results of the transient airspeed. This achieves an airspeed envelope protection scheme that utilizes dynamic principles and does not rely on traditional airspeed sensor observations, effectively reducing hardware and maintenance costs while ensuring flight safety.

Based on the above embodiment, the present disclosure also proposes a multi-rotor airspeed envelope protection device. The device includes a memory, a processor, and a computer program stored in the memory and executable on the processor. When the computer program is executed by the processor, it implements the steps of the multi-rotor airspeed envelope protection method as described in any of the above embodiments.

It should be noted that the device embodiment and the method embodiment are based on the same concept. The specific implementation details are described in the method embodiment, and the technical features in the method embodiment are correspondingly applicable in the device embodiment, which will not be repeated here.

Based on the above embodiments, the present disclosure also proposes a computer-readable storage medium storing a multi-rotor airspeed envelope protection program. When executed by a processor, the multi-rotor airspeed envelope protection program implements the steps of the multi-rotor airspeed envelope protection method as described in any of the above embodiments.

It should be noted that, in this document, the terms “include,” “comprise,” or any variants thereof are intended to cover non-exclusive inclusion, such that a process, method, article, or device that includes a series of elements encompasses not only those elements but also other elements not explicitly listed, or elements inherent to such a process, method, article, or device. In the absence of further restrictions, an element defined by the phrase “including a . . . ” does not preclude the existence of additional identical elements in the process, method, article, or device that includes the element.

From the description of the above embodiments, those skilled in the art can clearly understand that the methods of the above embodiments can be implemented by means of software combined with a necessary general-purpose hardware platform, or, of course, by hardware alone, though in many cases the former is the preferred implementation. Based on this understanding, the technical solution of the present disclosure, or the part thereof contributing to the prior art, can be embodied in the form of a software product. This computer software product is stored on a storage medium (such as ROM/RAM, magnetic disk, or optical disk) and includes several instructions to enable a terminal (which may be a mobile phone, computer, server, air conditioner, network device, etc.) to execute the methods described in the various embodiments of the present disclosure.

The embodiments of the present disclosure have been described above with reference to the accompanying drawings. However, the present disclosure is not limited to the specific embodiments described above, which are merely illustrative and not restrictive. Under the inspiration of the present disclosure, those of ordinary skill in the art can make many variations without departing from the spirit of the invention and the scope protected by the claims, all of which fall within the protection of the present disclosure.

### INDUSTRIAL APPLICABILITY

The multi-rotor airspeed calculation method, device, and computer-readable storage medium provided by the present disclosure involve establishing an airspeed calculation mathematical model; defining a function based on the airspeed calculation mathematical model for each calculation cycle and using the Newton iteration algorithm to solve the equation's root in real-time as the airspeed. This achieves an airspeed calculation scheme based on dynamic principles, fully utilizing dynamics principles and combining the unique control methods of multi-rotors. Without adding hardware sensors, it uses known attitude measurements and acceleration measurements as algorithm inputs, and calculates airspeed data with sufficient accuracy through software algorithms, simplifying the hardware structure, reducing the risk of electrical failure, and saving manufacturing, debugging, and maintenance costs. The multi-rotor airspeed envelope protection method and device provided by the embodiments of the present disclosure involve establishing an airspeed mathematical model; determining the correspondence between the maximum tilt angle and the maximum steady-state airspeed based on the airspeed mathematical model, and obtaining the tilt angle constraint parameter introduced into the attitude control based on the correspondence; calculating the transient airspeed based on the airspeed mathematical model, attitude measurements, and acceleration measurements, and executing the corresponding airspeed protection procedure based on the detection results of the transient airspeed. This achieves an airspeed envelope protection scheme that utilizes dynamic principles and does not rely on traditional airspeed sensor observations, effectively reducing hardware and maintenance costs while ensuring flight safety. Therefore, it has industrial applicability.

What is claimed is:

1. A multi-rotor airspeed calculation method, comprising:
establishing an airspeed calculation mathematical model k₁(θ)·V+k₂(θ)·V²+k₃(θ)·V³=mg tan θ−maₓ, where m is a mass, g is a gravitational acceleration, θ is a tilt angle, aₓ is an acceleration, V is an airspeed, and k₁(θ), k₂(θ), k₃(θ) are preset first-order, second-order, and third-order drag coefficient functions, respectively; and
defining a function ƒ(V) based on the airspeed calculation mathematical model for each calculation cycle, where ƒ(V)=k₃(θ)·V³+k₂(θ)·V²+k₁(θ)·V−mg tan θ+maₓ, with the tilt angle θ and the acceleration aₓ being real-time measured values of flight of a multi-rotor vehicle, and using a Newton iteration algorithm to solve a root of an equation ƒ(V)=0 in real time as the real-time airspeed V to control the flight of the multi-rotor vehicle.

2. The multi-rotor airspeed calculation method according to claim 1, wherein, before establishing the airspeed calculation mathematical model, the method comprises:
establishing a 6-degree-of-freedom (6DOF) dynamics constraint equation in a body horizontal coordinate system O−XYZ:
$$\{ \begin{matrix}\sum {F}_{Px} + \sum {F}_{Lx} + \sum {F}_{Dx} = {ma}_{x} + {mv}_{x} {w}_{z} \\ \sum {F}_{Py} + \sum {F}_{Ly} + \sum {F}_{Dy} = {ma}_{y} + {mv}_{y} {w}_{z} \\ \sum {F}_{Pz} + \sum {F}_{Lz} + \sum {F}_{Dz} - mg = {ma}_{z} \\ \sum {M}_{x} = {J}_{x} {α}_{x} + {\dot{J}}_{x} {w}_{x} + {J}_{x} {w}_{x} {w}_{z} \\ \sum {M}_{y} = {J}_{y} {α}_{y} + {\dot{J}}_{y} {w}_{y} + {J}_{y} {w}_{y} {w}_{z} \\ \sum {M}_{z} = {J}_{z} {α}_{z} + {\dot{J}}_{z} {w}_{z}\end{matrix} ;$$
where ΣF_{P} is a total thrust generated by propeller rotation, ΣF_{L} is a lift generated by movement of a fuselage of the multi-rotor vehicle in an airflow field, ΣF_{D} is a total aerodynamic drag of the multi-rotor vehicle, ΣM is a total torque of the multi-rotor vehicle, J is a moment of inertia of the multi-rotor vehicle, a is a linear acceleration of a center of mass, w is an angular velocity of a rigid body motion of the multi-rotor vehicle, and α is an angular acceleration of the rigid body motion of the multi-rotor vehicle.

3. The multi-rotor airspeed calculation method according to claim 2, wherein, before establishing the airspeed calculation mathematical model, the method further comprises:
under control law constraints of attitude stabilization, altitude hold, and position tracking, determining following assumptions:
a three-axis attitude changes slowly, with a three-axis angular velocity ωₓ≈ω_{y}≈ω_{z}≈0, a three-axis acceleration αₓ≈α_{y}≈α_{z}≈0;
vertical motion changes slowly, with a vertical acceleration a_{z}≈0;
a three-axis moment of inertia changes slowly, \dot{J}ₓ≈\dot{J}_{y}≈\dot{J}_{z}≈0; and
a propeller lift is significantly greater than a fuselage lift, i.e., ΣF_{Lx}≈0, ΣF_{Ly}≈0, ΣF_{Lz}≈0.

4. The multi-rotor airspeed calculation method according to claim 3, wherein, before establishing the airspeed calculation mathematical model, the method further comprises:
simplifying the 6DOF dynamics constraint equation based on the assumptions to obtain a 3-degree-of-freedom (3DOF) dynamics equation for longitudinal and lateral linear motions:
$$\{ \begin{matrix}\sum {F}_{Px} + \sum {F}_{Dx} = {ma}_{x} \\ \sum {F}_{Py} + \sum {F}_{Dy} = {ma}_{y} \\ \sum {F}_{Pz} - mg = 0\end{matrix} .$$

5. The multi-rotor airspeed calculation method according to claim 4, wherein, before establishing the airspeed calculation mathematical model, the method further comprises:
establishing a longitudinal motion dynamics constraint equation:
$$\{ \begin{matrix}{F}_{prop} sin θ - {F}_{drag} = {ma}_{x} \\ {F}_{prop} cos θ - mg = 0\end{matrix} ;$$
where Fₚᵣₒₚ is the total thrust generated by the propeller rotation, and F_{drag} is the total aerodynamic drag of the multi-rotor vehicle.

6. The multi-rotor airspeed calculation method according to claim 5, wherein, before establishing the airspeed calculation mathematical model, the method further comprises:
establishing a longitudinal motion aerodynamic drag constraint equation:
$${F}_{drag} = {k}_{1} ( θ ) \cdot V + {k}_{2} ( θ ) \cdot {V}^{2} + {k}_{3} ( θ ) \cdot {V}^{3} .$$

7. The multi-rotor airspeed calculation method according to claim 6, wherein establishing the airspeed calculation mathematical model comprises:
establishing the airspeed calculation mathematical model based on the longitudinal motion dynamics constraint equation and the longitudinal motion aerodynamic drag constraint equation:
$${k}_{1} ( θ ) \cdot V + {k}_{2} ( θ ) \cdot {V}^{2} + {k}_{3} ( θ ) \cdot {V}^{3} = mg tan θ - {ma}_{x} .$$

8. The multi-rotor airspeed calculation method according to claim 7, wherein the method further comprises:
performing airspeed calculation based on the airspeed calculation mathematical model under conditions of no wind at ground level, steady flow field, or turbulent gusts.

9. A multi-rotor airspeed envelope protection method, comprising:
establishing an airspeed mathematical model: m\dot{V}=−(k₁(θ)·V+k₂(θ)·V²+k₃(θ)·V³)+mg tan θ, where m is a mass, g is a gravitational acceleration, θ is a tilt angle, V is an airspeed, and k₁(θ), k₂(θ), k₃(θ) are first-order, second-order, and third-order drag coefficient functions, respectively;
determining a correspondence between a maximum tilt angle and a maximum steady-state airspeed based on the airspeed mathematical model, and obtaining a tilt angle restriction parameter introduced into attitude control based on the correspondence; and
calculating a transient airspeed based on the airspeed mathematical model, attitude measurement, and acceleration measurement, and executing a corresponding airspeed protection procedure based on a detection result of the transient airspeed.

10. The multi-rotor airspeed envelope protection method according to claim 9, wherein establishing the airspeed mathematical model comprises:
establishing an airspeed calculation mathematical model: maₓ=−(k₁(θ)·V+k₂(θ)·V²+k₃(θ)·V³)+mg tan θ, where aₓ is an acceleration; and
determining kinematic constraint satisfied by longitudinal motion:
$$\{ \begin{matrix}V = {V}_{wind} + {V}_{gnd} \\ {a}_{x} = {\dot{V}}_{gnd} = \dot{V} - {\dot{V}}_{wind}\end{matrix} ;$$
where V_{wind} is an incoming wind speed, and V_{gnd} is a ground speed.

11. The multi-rotor airspeed envelope protection method according to claim 10, wherein establishing the airspeed mathematical model further comprises:
for a steady flow field with no wind, constant, or slowly varying gusts, setting \dot{V}_{wind}≈0;
for an unsteady flow field with gusts, setting \dot{V}_{wind}≈0 in a steady state; and
combining the airspeed calculation mathematical model and the kinematic constraint satisfied by the longitudinal motion to establish the airspeed mathematical model.

12. The multi-rotor airspeed envelope protection method according to claim 11, wherein determining the correspondence between the maximum tilt angle and the maximum steady-state airspeed based on the airspeed mathematical model, and obtaining the tilt angle restriction parameter introduced into the attitude control based on the correspondence, comprises:
defining that when \dot{V}=0, the airspeed V determined by the airspeed mathematical model is an equilibrium airspeed Vₑ(θ) for a given tilt angle θ, where each tilt angle θ uniquely corresponds to an equilibrium airspeed Vₑ(θ), and for a given tilt angle θ, following relationships hold:
when V<Vₑ(θ), \dot{V}>0;
when V>Vₑ(θ), \dot{V}<0;
combining a fact that the equilibrium airspeed Vₑ(θ) is a stable equilibrium state of the airspeed V under the tilt angle θ, determining a mapping relationship between the tilt angle θ and the equilibrium airspeed Vₑ(θ); and
when the maximum tilt angle θₘₐₓ is restricted by a control algorithm, determining that a steady-state airspeed is restricted to a maximum value V_{e_max}.

13. The multi-rotor airspeed envelope protection method according to claim 12, wherein determining the correspondence between the maximum tilt angle and the maximum steady-state airspeed based on the airspeed mathematical model, and obtaining the tilt angle restriction parameter introduced into the attitude control based on the correspondence, further comprises:
conducting flight tests, setting different tilt angle restrictions θₘₐₓ each time, and iterating through a possible range of the tilt angle restrictions θₘₐₓ with a step size of 1 degree; and
determining a numerical correspondence table between the maximum tilt angle θₘₐₓ and the maximum steady-state airspeed V_{e_max} based on traversal data from the flight tests.

14. The multi-rotor airspeed envelope protection method according to claim 13, wherein determining the correspondence between the maximum tilt angle and the maximum steady-state airspeed based on the airspeed mathematical model, and obtaining the tilt angle restriction parameter introduced into the attitude control based on the correspondence, further comprises:
when a given airspeed envelope Vₘₐₓ is provided with a 25% gust margin reserved, determining the maximum steady-state airspeed V_{e_max}=(1−25%)*Vₘₐₓ; and
determining the maximum tilt angle θₘₐₓ based on the numerical correspondence table, and setting the maximum tilt angle θₘₐₓ as the tilt angle restriction parameter for an attitude control algorithm.

15. The multi-rotor airspeed envelope protection method according to claim 14, wherein calculating the transient airspeed based on the airspeed mathematical model, the attitude measurement, and the acceleration measurement, and executing the corresponding airspeed protection procedure based on the detection result of the transient airspeed, comprises:
detecting whether the calculated transient airspeed exceeds a threshold at a frequency of 1 Hz;
executing the corresponding airspeed protection procedure when the transient airspeed exceeds the threshold.

16. The multi-rotor airspeed envelope protection method according to claim 15, wherein calculating the transient airspeed based on the airspeed mathematical model, the attitude measurement, and the acceleration measurement, and executing the corresponding airspeed protection procedure based on the detection result of the transient airspeed, further comprises:
when k1*Vₘₐₓ≤V<k2*Vₘₐₓ, sending a warning message to a ground station and requiring a remote crew to continuously monitor an airspeed status;
when k2*Vₘₐₓ≤V<Vₘₐₓ, actively reducing a target speed through a flight controller and decreasing the tilt angle until the airspeed is below k1*Vₘₐₓ;
when V≥Vₘₐₓ, controlling a multi-rotor vehicle through the flight controller to decelerate to a hover state and initiating a return or landing;
where k1<k2.

17. A multi-rotor envelope protection device, comprising a memory, a processor, and a computer program stored in the memory and executable on the processor, wherein the computer program, when executed by the processor, implements steps of the airspeed envelope protection method according to claim 9.

18. A computer-readable storage medium having a multi-rotor airspeed calculation program stored thereon, wherein the multi-rotor airspeed calculation program, when executed by a processor, implements steps of the airspeed envelope protection method according to claim 9.
